(19) United States
(12) Patent Application Publication
(10) Pub. No.: US 2006/0173603 A1
(43) Pub. Date: Aug. 3, 2006

(54) Slip loss reduction control system for improving driveline efficiency

(76) Inventors: Sankar K. Mohan, Jamesville, NY (US); Eric A. Bansbach, Fayetteville, NY (US); Anupam Sharma, East Syracuse, NY (US)

Correspondence Address: DERGOSITS & NOAH LLP, FOUR EMBARCADERO CENTER, SUITE 1450, SAN FRANCISCO, CA, 94111, US

(21) Appl. No.: 11/301,084

(22) Filed: Dec. 12, 2005

Related U.S. Application Data
(60) Provisional application No. 60/649,217, filed on Feb. 2, 2005.

(51) Int. Cl. G06F 17/00

(52) U.S. Cl. 701/71; 701/1

(57) ABSTRACT

A method is provided for reducing slip loss experienced by the tires of a vehicle. The method includes: determining a longitudinal force associated with each tire; determining an optimal slip coefficient for each tire based in part on the corresponding longitudinal force for the tire; and determining a torque to be applied to each tire based in part on the optimal slip coefficient, thereby reducing the slip loss experienced by the tires of the vehicle. This method is typically employed in the absence of other control algorithms used by a vehicle's traction control system.

### CROSS-REFERENCE TO RELATED APPLICATIONS

This application claims the benefit of U.S. Provisional Application No. 60/649,217 filed Feb. 2, 2005.

### FIELD OF THE INVENTION

The present invention relates to vehicle traction control systems and, more particularly, to a method for reducing slip loss experienced by the tires of a vehicle, thereby improving driveline efficiency.

### BACKGROUND OF THE INVENTION

Slip conditions, applied torque, and the vertical force between the tire patch and the road surface collectively define the amount of tractive effort at each wheel of a motor vehicle. An associated phenomena at a given tire patch is the slip losses resulting from hysteresis within the tire. Since these losses are direct functions that depend on tire load, longitudinal force and slip, one can conceptualize a method of optimizing performance by reducing the slip losses occurring at each tire patch. Therefore, it is desirable to provide a method for reducing slip loss experienced by the tires of a vehicle, thereby improving driveline efficiency.

### SUMMARY OF THE INVENTION

In accordance with the present invention, a method is provided for reducing slip loss experienced by the tires of a vehicle. The method includes: determining a longitudinal force associated with each tire; determining an optimal slip coefficient for each tire based in part on the corresponding longitudinal force for the tire; and determining a torque to be applied to each tire based in part on the optimal slip coefficient, thereby reducing the slip loss experienced by the tires of the vehicle. This method is typically employed in the absence of other control algorithms used by the vehicle's traction control system.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a flowchart illustrating a slip loss reduction algorithm in accordance with the present invention; and

FIG. 2 is a flowchart illustrating a method for improving overall driveline efficiency of a vehicle by employing the slip loss reduction algorithm of the present invention.

### DETAILED DESCRIPTION OF THE PREFERRED EMBODIMENTS

For any tire patch, it is possible to define a load and torque dependent efficiency as follows. If h is the loaded radius of the tire, and T is the torque being sent through the tire, the longitudinal force Fx the tire generates is

$${F}_{x} = \frac{T}{h} \qquad ( 1 )$$

The force generation is linked to a “slip” generation at the tire patch and vice versa. This slip σ is defined as

$$σ = \frac{ω {R}_{e}}{V} - 1 \qquad ( 2 )$$

where V is the vehicle speed, ω is the tire angular velocity and Rₑ is the effective radius of the tire. This definition of σ assumes that there is no side slip present. For small values of σ, the relationship between Fₓ and σ is linear. This relationship is complex when σ is high, but in high σ cases, the directional stability and performance controllers will over-ride the slip loss reduction algorithm set forth below. So for the region of interest,
Fₓ=μF_{z} (3)
where μ is the friction coefficient and F_{z} is the vertical load on the tire patch. μ in turn depends linearly on σ, i.e.
μ=Kσμₘₐₓ (4)
where the coefficient K is primarily dependent on the elastic properties of the tire and μₘₐₓ is the actual value of the road friction coefficient at the tire patch.

In an all-wheel drive vehicle, it is possible to send torque to any or all of the four wheels. Thus, σ, K and Fₓ are different for all four tires. For such a vehicle, the tire patch efficiency η, can be defined as

$$η = 1 - \frac{{{\sum }_{1}}^{4} \frac{{F}_{xi} {σ}_{i}}{1 - {σ}_{i}}}{{{\sum }_{1}}^{4} \frac{{F}_{xi}}{1 - {σ}_{i}}} \qquad ( 5 )$$

Conventionally, optimization problems are treated as minimization problems rather than maximization problems, it is convenient to define the objective function to be minimized as

$$f ( {σ}_{1} , {σ}_{2} , {σ}_{3} , {σ}_{4} ) = \frac{{{\sum }_{1}}^{4} \frac{{F}_{xi} {σ}_{i}}{1 - {σ}_{i}}}{{{\sum }_{1}}^{4} \frac{{F}_{xi}}{1 - {σ}_{i}}} \qquad ( 6 )$$

The optimal value of σ for all four wheels will minimize the objective function and maximize the efficiency of the system. By controlling torque sent to each wheel, it is possible to control σ for each wheel. For any wheel i,

$${σ}_{I} = \frac{{T}_{i}}{{h}_{i} {K}_{i} {F}_{zi} {μ}_{max i}} \qquad ( 7 )$$

where torque Tᵢ sent to the wheel is controlled. The variables in the denominator hᵢ, Kᵢ, F_{zi} and μₘₐₓ are environmental factors that vary with time and space. So as these factors vary at each wheel, the torque sent to the wheels has to be changed for maximum system efficiency. Variation in hᵢ are expected to be small and therefore, hᵢ may be treated as a constant to keep the computational costs involved down to acceptable limits. In compact notation,

$$σ = \frac{{T}_{i}}{{E}_{i}} \qquad ( 8 )$$

where Eᵢ is the product of all the environmental factors affecting the relationship between torque and longitudinal slip. It is readily understood that Eᵢ is a function of time.

Based on this theorem, a slip loss reduction algorithm is proposed for reducing slip loss experienced by the tires of a vehicle. Briefly, an optimal slip coefficient is computed for each tire in accordance with the tire patch efficient function defined in equation (5) above. The torque to be applied to each tire is then determined based in part on the optimal slip coefficient for the corresponding tire. In this way, it is possible to reduce slip loss experienced by the tires of the vehicle and improve the overall efficiency of the system.

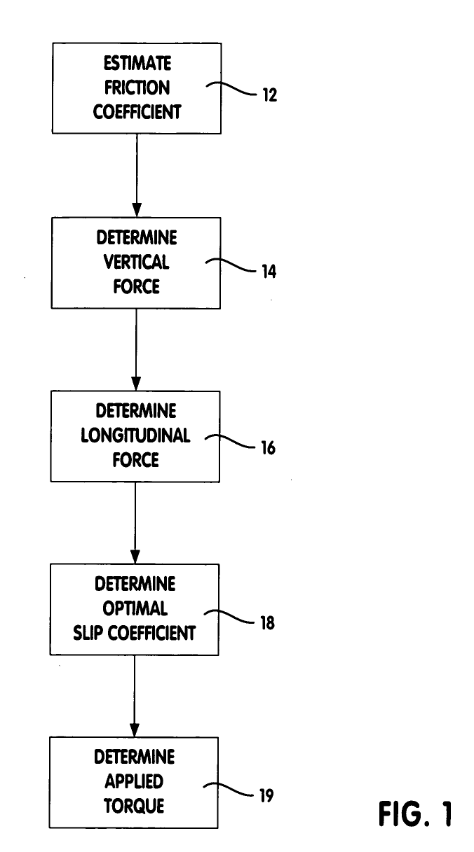

Referring to FIG. 1, a friction coefficient between the tires and the driving surface being traversed by the vehicle is first estimated as shown at step 12. In an exemplary embodiment, the friction coefficient may be estimated using the known Pacejka tire model. Since the Pacejka tire model is typically not accurate at lower vehicle speeds, a different estimation technique may be employed at lower vehicle speeds. Alternatively, the slip loss reduction algorithm may be deactivated at low vehicle speeds. It is readily understood that other ways for estimating the friction coefficient may also be employed within the context of the present invention.

The vertical force, Fz, on each wheel is determined at step 14. Vertical force may be defined as a four-dimensional vector, such that each dimension represents the vertical load on each wheel of the vertical. In a vehicle having an active suspension system, this information may be input from this system; otherwise, the vertical force can be estimated using one of various techniques known in the industry. At step 16, the longitudinal force, Fx, the tire generates is computed by multiplying the vertical force vector by the friction coefficient as described above.

Next, an optimal slip coefficient is determined at step 18 for each tire based in part on the corresponding longitudinal force for the tire. To do so, the objective function defined above is minimized. While an exemplary minimization algorithm is set forth below, it is readily understood that other known minimization techniques are also within the broader aspects of the present invention.

For the vector space σ={σ1, σ2, σ3, σ4}. The gradient of a function f(σ) is

$${f}^{′} ( σ ) = [ \frac{\partial f}{\partial {σ}_{1}} \frac{\partial f}{\partial {σ}_{2}} \frac{\partial f}{\partial {σ}_{3}} \frac{\partial f}{\partial {σ}_{4}} ] \qquad ( 10 )$$

The Hessian of this function is

$${f}^{″} ( σ ) = [ \begin{matrix}\frac{{\partial }^{2} f}{{\partial }^{2} {σ}_{1}} & \frac{{\partial }^{2} f}{\partial {σ}_{1} \partial {σ}_{2}} & \frac{{\partial }^{2} f}{\partial {σ}_{1} \partial {σ}_{3}} & \frac{{\partial }^{2} f}{\partial {σ}_{1} {σ}_{4}} \\ \frac{{\partial }^{2} f}{\partial {σ}_{2} {σ}_{1}} & \frac{{\partial }^{2} f}{{\partial }^{2} {σ}_{2}} & \frac{{\partial }^{2} f}{\partial {σ}_{2} \partial {σ}_{3}} & \frac{{\partial }^{2} f}{\partial {σ}_{2} \partial {σ}_{4}} \\ \frac{{\partial }^{2} f}{\partial {σ}_{3} \partial {σ}_{1}} & \frac{{\partial }^{2} f}{\partial {σ}_{3} \partial {σ}_{2}} & \frac{{\partial }^{2} f}{{\partial }^{2} {σ}_{3}} & \frac{{\partial }^{2} f}{\partial {σ}_{3} \partial {σ}_{4}} \\ \frac{{\partial }^{2} f}{\partial {σ}_{4} \partial {σ}_{1}} & \frac{{\partial }^{2} f}{\partial {σ}_{4} \partial {σ}_{2}} & \frac{{\partial }^{2} f}{\partial {σ}_{4} \partial {σ}_{3}} & \frac{{\partial }^{2} f}{{\partial }^{2} {σ}_{4}}\end{matrix} ] \qquad ( 11 )$$

where f″ (σ) is a symmetric matrix.

Given a function f^{(σ)}, a starting value ^{σ}^{₀}, a maximum number of CG iterations ⁱ^{ₘₐₓ}, and a Newton-Raphson error tolerance<1, a non-linear conjugate gradient algorithm is defined as follows:

i = 0;′
k = 0;
r = - f′ (σ₀);
d = r;
δ_{new} = r^{T} r;
δ₀ = δ_{new};
$α = - \frac{{[ {f}^{′} ( {\vec{σ}}_{0} ) ]}^{T} d}{{d}^{T} {f}^{″} ( {\vec{σ}}_{0} ) d} ;$
σ_{old} = σ₀;
while i < i_{MAX} and δ_{new} > ²do

j = 0;
δ_{d} = d^{T} d;
while j<jₘₐₓ and α²δ_{d} > ² do

$\begin{matrix}α = - \frac{{[ {f}^{′} ( {\vec{σ}}_{0} ) ]}^{T} d}{{d}^{T} {f}^{″} ( {\vec{σ}}_{0} ) d} ; \\ σ = {σ}_{old} + αd ; \\ j = j + 1 ;\end{matrix}$

end
σ_{old} = σ;
r = - f′ (σ);
δ_{old} = δ_{new};
$\begin{matrix}{δ}_{new} = {r}^{T} r ; \\ β = \frac{{δ}_{new}}{{δ}_{old}} ;\end{matrix}$
d = r + βd;
k = k + 1;
if k = n or d ≦ 0 then

d = r′
k = 0;

end
i = i + 1;

end

The non-linear conjugate gradient is restarted whenever the search direction is not the descent direction (d≦0). It is also restarted every n iterations, to improve convergence.

Lastly, a torque to be applied to each tire is computed at step 19 in part based on the optimal slip coefficient. Specifically, the applied torque is calculated in accordance with equation (7) set forth above. In this way, an applied torque may be computed to each wheel of the vehicle.

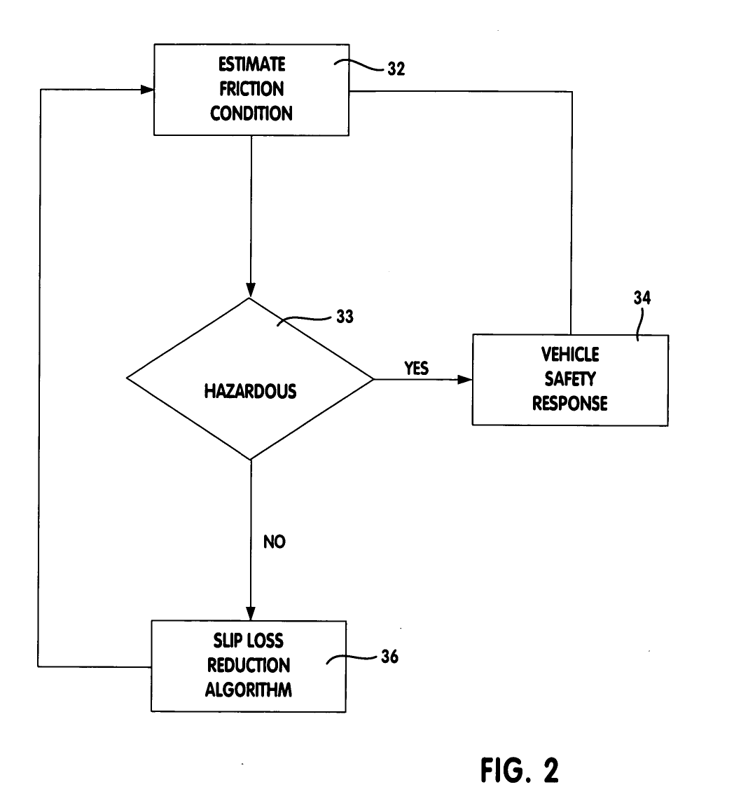

In another aspect of the present invention, the slip loss reduction algorithm described above may cooperatively operate with other vehicle safety systems to improve overall driveline efficiency as shown in FIG. 2. During operation of the vehicle, various vehicle safety systems may operate to detect hazardous driving conditions as shown at step 32. For example, a traction control system is design to provide traction control and directional stability control. In response to a detected hazardous driving condition, a vehicle safety response may be taken at step 34 by an applicable vehicle safety system. When the traction control system detects a loss of traction, it may respond by maximizing tractive force at each tire patch without compromising lateral stability. When the traction control system detects a loss of directional stability, it may respond by varying the tractive force at each tire to provide a yaw moment correction needed to maintain a driver's intended vehicle direction. It is readily understood that a vehicle may employ other types vehicle safety systems, such as an automatic braking system.

Whenever a vehicle safety response is not required, the slip loss reduction algorithm may be employed at step 36, thereby reducing slip loss experienced by the tires of the vehicle during non-hazardous driving conditions. Since most vehicle operation occurs under non-hazardous driving conditions, it is readily understood that reduction of slip loss will result in substantial fuel savings. Although the slip loss reduction algorithm is preferably mutually exclusive of other control strategies which impact the amount of torque applied to the wheels, it is envisioned that it may cooperatively operate concurrently either partially or entirely with one or more of these other control strategies.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for reducing slip loss experienced by the tires of a vehicle, comprising:
determining a longitudinal force associated with each tire;
determining an optimal slip coefficient for each tire based in part on the corresponding longitudinal force for the tire; and
determining a torque to be applied to each tire based in part on the optimal slip coefficient, thereby reducing the slip loss experienced by the tires of the vehicle.

2. The method of claim 1 wherein determining a longitudinal force further comprises:
estimating a friction coefficient between the tires of the vehicle and a driving surface being traversed by the vehicle;
determining a vertical force exerted on each tire; and
multiplying the friction coefficient by the vertical force for a given tire to determine the longitudinal force for the given tire.

3. The method of claim 2 wherein the friction coefficient is estimated using a Pacejka tire model.

4. The method of claim 1 wherein slip efficiency for the tires of the vehicle is defined by a function as
$$η = 1 - \frac{{{\sum }_{1}}^{4} \frac{{F}_{xi} {σ}_{i}}{1 - {σ}_{i}}}{{{\sum }_{1}}^{4} \frac{{F}_{xi}}{1 - {σ}_{i}}}$$
where Fₓ is the longitudinal force associated with a given tire and σ is a slip coefficient for the given tire, such that minimizing the function yields the optimal slip coefficient for the given tire.

5. The method of claim 1 wherein determining a torque for a given wheel, Tᵢ, is calculated in accordance with
Tᵢ=σᵢhᵢKᵢF_{zi}μₘₐₓ
where σᵢ is the optimal slip coefficient for the given wheel, hᵢ is the load radius for the tire on the given wheel, Kᵢ correlates to elastic properties of the tire of the given wheel, F_{zi} is the vertical force on the given wheel, and μₘₐₓᵢ is an actual value of the road friction coefficient at the tire patch of the given wheel.

6. A method for improving driveline efficiency of a vehicle having an active traction control system, comprising:
monitoring driving conditions during vehicle operation;
performing a vehicle safety action using the traction control system in response to a hazardous driving conditions; and
reducing slip loss experienced by the tires of the vehicle during non-hazardous driving conditions.

7. The method of claim 7 wherein reducing slip loss further comprises
determining a longitudinal force associated with each tire;
determining an optimal slip coefficient for each tire based in part on the corresponding longitudinal force for the tire; and
determining a torque to be applied to each tire based in part on the optimal slip coefficient, thereby reducing the slip loss experienced by the tires of the vehicle.

8. The method of claim 8 wherein determining a longitudinal force further comprises:
estimating a friction coefficient between the tires of the vehicle and a driving surface being traversed by the vehicle;
determining a vertical force exerted on each tire; and
multiplying the friction coefficient by the vertical force for a given tire to determine the longitudinal force for the given tire.

9. The method of claim 9 wherein the friction coefficient is estimated using a Pacejka tire model.

10. The method of claim 8 wherein slip efficiency for the tires of the vehicle is defined by a function as
$$η = 1 - \frac{{{\sum }_{1}}^{4} \frac{{F}_{xi} {σ}_{i}}{1 - {σ}_{i}}}{{{\sum }_{1}}^{4} \frac{{F}_{xi}}{1 - {σ}_{i}}}$$
where Fₓ is the longitudinal force associated with a given tire and σ is a slip coefficient for the given tire, such that minimizing the function yields the optimal slip coefficient for the given tire.

11. The method of claim 8 wherein determining a torque for a given wheel, Tᵢ, is calculated in accordance with
Tᵢ=σᵢhᵢKᵢF_{zi}μmaxi
where σᵢ is the optimal slip coefficient for the given wheel, hᵢ is the load radius for the tire on the given wheel, Kᵢ correlates to elastic properties of the tire of the given wheel, F_{zi} is the vertical force on the given wheel, and μₘₐₓᵢ is an actual value of the road friction coefficient at the tire patch of the given wheel.

12. The method of claim 7 wherein the vehicle safety action is further defined as maximizing tractive force at each tire patch without compromising lateral stability.

13. The method of claim 7 wherein the vehicle safety action is further defined as varying tractive force at each tire to provide a yaw moment correction needed to maintain a driver's intended vehicle direction.
